(19) United States
(12) Patent Application Publication
(10) Pub. No.: US 2026/0226931 A1
(43) Pub. Date: Aug. 6, 2026

(54) MOUNTING DEVICE FOR MOUNTING AN ITEM TO A PANEL

(71) Applicant: Robin Peter Michael ASTBURY, Richmond (GB)

(72) Inventor: Robin Peter Michael ASTBURY, Richmond (GB)

(21) Appl. No.: 19/148,429

(22) PCT Filed: Jan. 15, 2024
(86) PCT No.: PCT/GB2024/050089

§ 371 Date: Jul. 16, 2025

(30) Foreign Application Priority Data
Jan. 16, 2023 (GB) 2300596.0

(51) Int. Cl. F16B 13/08

(52) U.S. Cl. CPC F16B 13/0808

(57) ABSTRACT

A mounting device is configured to be coupled to a panel. The mounting device comprises a mounting bolt comprising a head and a shank that is provided with external threading, and an end face of the head of the mounting bolt is provided with a mounting point that is configured to receive and retain a fastener for mounting an item to the panel. A fixing component comprises a nut having a threaded bore that is engageable with the external threading of the shank of the mounting bolt and at least one arm pivotably mounted to the fixing component and alterable between an insertable condition and an engageable condition. In the insertable condition the fixing component is insertable through an aperture in said panel from a first side of said panel, and in the engageable condition at least one arm is engageable with a second side of the panel.

### CROSS-REFERNCE TO RELATED APPLICATIONS

This application is a U.S. National Phase application of PCT/GB2024/050089, filed Jan. 15, 2024, which claims the benefit of GB 2300596.0, filed on Jan. 16, 2023, the disclosure of which are incorporated by reference herein in their entireties.

### FIELD OF THE INVENTION

The present invention relates to a mounting device for mounting an item to a panel, and particularly to a mounting device for mounting an item to a plasterboard or drywall panel. Aspects of the invention relate to a mounting device, to a mounting assembly comprising a mounting device coupled to a panel, to a mounting bolt for mounting an item to a panel, and to a kit of parts for forming a mounting device.

### BACKGROUND OF THE INVENTION

Many buildings include walls that are formed of or covered with plasterboard or drywall panels. It is often desirable to mount items including, for example, pictures, clocks and mounting brackets for shelves and televisions to such plasterboard panels.

Conventional screws generally do not provide a secure interface when screwed directly into a plasterboard panel. Various mounting systems have therefore been developed for providing an improved mounting interface with a plasterboard panel.

One common mounting system uses a metal or plastics anchor comprising a tubular body with integrally formed external screw threading that is configured to be screwed directly into a plasterboard panel, and an internal aperture that is configured to receive a screw which may be used to mount an item to the plasterboard panel. However, mounting systems of this type may not be suitable for securing heavy loads.

Another common mounting system uses an expandable anchor such as a toggle mounting bolt or spring toggle that is connected to a threaded mounting bolt and configured to be inserted through a pre-drilled hole in a plasterboard panel. The anchor is switchable between a retracted configuration in which it can be passed through the hole in the plasterboard panel and an expanded configuration in which it is capable of engaging a rear surface of the plasterboard panel in order to resist outward movement of the mounting bolt. Mounting systems of this type are generally capable of supporting heavier loads. However, mounting systems of this type are generally only suitable for supporting items that can be clamped between the head of the mounting bolt and the plasterboard panel, such as brackets with appropriately sized mounting bolt-receiving apertures. In addition, mounting systems of this type cannot be pre-installed in a plasterboard panel, but instead need to be installed at the point of mounting (at the same time as the item that is to be mounted to the plasterboard panel). Mounting systems of this type must also be disassembled in order to allow the item to be removed from the plasterboard panel.

Another known mounting system uses an anchoring insert comprising a cylindrical body that is configured to be received in a pre-drilled hole in a plasterboard panel, a set of retention arms provided at a distal end of the body that are configured to be expanded in order to engage a rear surface of the plasterboard panel and resist outward movement of the body from the plasterboard panel, and a mounting point provided at a proximal end of the body that is configured to receive a fastener which may be used to mount an item to the plasterboard panel. However, mounting systems of this type are more mechanically complex and expensive, and require a hole of a specific size to be present in the plasterboard panel.

The present invention aims to address disadvantages of known mounting systems for mounting items to plasterboard panels.

### SUMMARY OF THE INVENTION

According to the present invention there is provided a mounting device that is configured to be coupled to a panel, the mounting device comprising:

a mounting bolt comprising a head and a shank that is provided with external threading, and an end face of the head of the mounting bolt is provided with a mounting point that is configured to receive and retain a fastener for mounting an item to the panel;
a fixing component comprising a nut having a threaded bore that is engageable with the external threading of the shank of the mounting bolt and at least one arm pivotably mounted to the fixing component and alterable between an insertable condition and an engageable condition, wherein in the insertable condition the fixing component is insertable through an aperture in said panel from a first side of said panel, and in the engageable condition at least one arm is engageable with a second side of the panel; and
a washer having:
a hollow body that is configured to be received within the aperture in the panel;
at least one engagement formation that is configured to resist movement of the washer through the aperture in the panel;
at least one engagement surface configured to be engaged by an underside of the head of the mounting bolt in order to prevent the head of the mounting bolt from passing through the hollow body;
wherein:
the head of the mounting bolt is configured to be at least partially received within the hollow body of the washer when the underside of the head of the mounting bolt engages the engagement surface.

In some embodiments, said fastener is one of a bolt, a machine screw, a self-tapping screw, a nail, a hook, or eyebolt.

In some embodiments the washer includes an element arranged to cooperate with the fixing component to prevent the fixing component from rotating with respect to said washer.

In some embodiments the or each at least one arm of the fixing component includes hinged arm means arranged to be contacted and rotated by the mounting bolt when the mounting bolt is inserted into the fixing component so as to open the at least one arm from a closed position such that the at least one arm is/are able to be engaged, in operation, with a first, inner, side of said panel.

In some embodiments the mounting device is arranged to be secured to a panel, said panel having an inner first face and an outer second face, the mounting device including locating means arranged to be mounted in a recess in the outer face of said panel, said locating means having an end wall with an aperture therethrough for accepting a member having an externally threaded shank and an internal portion providing a mounting point configured to receive and retain a fastener for attaching an item to said panel, said threaded shank of said member being arranged to cooperate with an internally threaded member having arm means that is radially extendable outwardly from said internally threaded member and arranged, in use, to abut the inner first face of said panel to secure said mounting device to said panel independently of the fastener for attaching said item.

In some embodiments the mounting device comprises a mounting bolt comprising a head and a shank that is provided with external threading; a fixing component comprising a nut having a threaded bore that is engageable with the external threading of the shank of the mounting bolt and at least one arm pivotably mounted to the fixing component between an insertable condition through an aperture in said panel and an engageable condition with said panel, wherein in the insertable condition the mounting device is removably insertable in said aperture in said panel from a first side of said panel, and in the engageable condition at least one arm is engageable with a second side of the panel, and a washer comprising an axial aperture through which the mounting bolt extends, the washer being located between the head of the mounting bolt and the fixing component, wherein an end face of the head of the mounting bolt is provided with a mounting point that is configured to receive and retain a fastener for mounting an item to the panel.

The mounting device is configured to be mounted to a panel such as a plasterboard panel with the mounting bolt extending through an aperture in the panel, the washer engaging the panel to resist movement of the mounting bolt in a first direction from a first side of the panel towards a second side of the panel, and the at least one arm of the fixing component engaging the second surface of the panel to resist movement of the mounting bolt in a second direction opposed to the first direction. The mounting device is particularly secure, mechanically simple and easy to assemble, can be pre-installed in a panel (instead of requiring installation at the point of mounting), and provides a convenient mounting point that may be used to secure a further fastener such as a bolt, machined screw, self-tapping screw or nail to the panel for the purpose of mounting an item to the panel.

In some embodiments the at least one arm is arranged to articulate around an axis that is tangential to a longitudinal axis of the washer, fixing component and mounting bolt.

In some embodiments the at least one arm has an articulation axis which is coaxial with a longitudinal axis of the washer, fixing component and mounting bolt.

In some embodiments at least one arm is secured by a pin received into a mounting block formed on the fixing component.

In some embodiments the at least one arm is an integral part of the fixing component secured thereto by a resiliently deformable hinge region.

In some embodiments a mounting device further comprises a biasing system that is configured to urge the at least one arm to the engageable condition.

In some embodiments the or at least one arm of the fixing component includes hinged arm means arranged to be contacted and rotated by the mounting bolt when the mounting bolt is inserted into the fixing component to cause the arms to articulate from the insertable condition to the engageable condition.

In some embodiments the fixing component comprises a spring toggle or a pivoting toggle bar.

In some embodiments the mounting point comprises a threaded bore that is configured to receive a threaded shank of a fixing mounting bolt or machine screw.

The fixing component may comprise a spring toggle. It will be appreciated that a spring toggle is a fixing component comprising a nut with a threaded bore and a pair of spring-loaded arms or wings that are connected to the nut and configured to be deflected inwardly towards each other in order to facilitate passage of the fixing through an aperture in a panel, and to subsequently move back apart once the fixing has passed through the aperture and engage a rear surface of the panel in order to resist outward movement of a mounting bolt that is engaged with the nut of the spring toggle. However, other types of toggle may also be used. For example, in another embodiment the fixing component may comprise a pivoting toggle bar including a single, rigid arm that is pivotally connected to a threaded nut.

In some embodiments the mounting point may comprise a deformable core that is configured to receive a screw with a self-tapping thread or a nail.

The deformable core may comprise a solid block of natural or reconstituted wood or plastics material, optionally with fibre reinforcement. Other deformable materials may also be used, as long as the material of the core is capable of receiving and retaining a screw or nail.

The deformable core may be formed as a solid block, and may not include any central guide aperture. The lack of a central guide aperture may prevent a screw or nail that is being driven into the deformable core from being automatically aligned with the central axis of the deformable core, thereby facilitating positioning of a screw or nail at any desired location and angle with respect to the deformable core.

The mounting point may extend in a direction aligned with a longitudinal axis of the mounting bolt through the head of the mounting bolt, and optionally along at least a portion of the shank of the mounting bolt.

The mounting point may extend along the entire length of the mounting bolt from the end face of the head to a distal tip of the shank. Alternatively, the shank of the mounting bolt may comprise an enlarged section located adjacent to the head of the mounting bolt and a threaded portion located outboard of the enlarged section, the enlarged section having a width or diameter that is greater than the diameter of the threaded portion of the shank, and the mounting point may extend through the head of the mounting bolt and into the enlarged section of the shank, preferably without extending beyond the enlarged section into the threaded portion of the shank. In this case the mounting point may optionally have a width or diameter that is equal to or greater than the diameter of the threaded portion of the shank.

The head of the mounting bolt may be configured to be engaged by a tool in order to facilitate rotation of the mounting bolt during installation of the mounting device. The head of the mounting bolt may, for example have a hexagonal or other polygonal shape when viewed in a direction aligned with the longitudinal axis of the mounting bolt in order to facilitate rotation of the mounting bolt using a wrench, spanner or socket; may comprise a socket in its end face in order to facilitate rotation of the mounting bolt using a correspondingly shaped key; or may comprise one or more slots in its end face in order to facilitate rotation of the mounting bolt using a screwdriver.

Alternatively, or in addition, the head of the mounting bolt may be provided with a handle that is pivotable with respect to the head of the mounting bolt between a stowage position and a deployed position, the handle extending outwardly beyond the end face of the head of the mounting bolt and being configured to be gripped in order to facilitate rotation of the mounting bolt when in the deployed position. The handle may be gripped by a user's fingers or alternatively by a tool such as a pair of pliers in order to facilitate rotation of the mounting bolt. The handle may also allow the mounting bolt to be pulled in an outward direction away from a panel during installation of the mounting device in order to bring the fixing component into contact with a rear side of the panel, thereby facilitating tightening of the mounting device.

The handle may be pivotable with respect to the head of the mounting bolt about an axis that is arranged perpendicular to a longitudinal axis of the mounting bolt. The handle may extend in a plane that is perpendicular to the longitudinal axis of the mounting bolt while in the stowage position, and in a plane that is parallel to the longitudinal axis of the mounting bolt while in the deployed position.

The handle may be connected to the head of the mounting bolt at first and second attachment points located on opposite sides of the head of the mounting bolt. The attachment points may comprise a pair of bosses provided on the handle that are received within a corresponding pair of recesses provided on opposite sides of the head of the mounting bolt.

In some embodiments the entire head of the mounting bolt is configured to be received within the hollow body of the washer.

In some embodiments the at least one engagement formation comprises a flange that extends radially outwardly from the hollow body of the washer and/or a plurality of longitudinally extending fins that extend radially outwardly from the hollow body of the washer.

It will be understood the head of the mounting bolt may be configured to be at least partially received within the hollow body of the washer. In this case at least a portion of the head of the mounting bolt, and preferably the entire head of the mounting bolt from an underside to the end face thereof, may advantageously be recessed into a panel on which the mounting device is installed such that the head of the mounting bolt does not protrude outwardly beyond a front side of the panel. The end face of the head of the mounting bolt may be at least substantially level with or inwardly recessed with respect to a proximal end of the washer when the head of the mounting bolt is fully located inside the hollow body of the washer (the proximal end of the washer being the end of the washer that faces away from the distal tip of the shank of the mounting bolt and the fixing component).

In some embodiments there is provided at least one retaining element for preventing the fixing component from completely separating at a distal end of the washer.

In some embodiments the washer has a cylindrical outer wall in which are disposed slots and the fixing component has flanges which are arranged to slide within said slots in the washer to thereby prevent the fixing component from rotating with respect to the washer and the fixing component is axially slidable within said washer, and said washer has restraining means for retaining the fixing means within the washer.

In some embodiments the washer has spaced along its longitudinal axis, an upper part and a lower part which are joined by posts and said fixing component has external slots in an outer side wall of the fixing component for axially slidable location on the posts, whereby the fixing component is mounted between the upper part and the lower part.

In some embodiments the lower part at a distal end from the upper part has an end wall extending radially inwardly to capture the fixing component between the upper part and the lower part.

In some embodiments the washer further includes arm engagement means that are arranged to contact the at least one arm, whereby when the fixing component travels axially from the engageable position to the insertion position so the arm engagement means urge the at least one arm means to pivot from the engageable condition to the insertable condition.

In some embodiments the washer includes fixing component anti-rotation means arranged to cooperate with the fixing component to prevent the fixing component from rotating with respect to said washer.

The mounting device may further comprise a biasing system that is configured to bias the fixing component in a direction towards the washer during installation of the mounting device.

In some embodiments the biasing system comprises a compression spring located between the washer and an underside of the head of the mounting bolt.

In some embodiments the biasing system comprises at least one tension spring that extends between the fixing component and the washer.

The biasing system may, for example, comprise a compression spring, for example a metal coil spring, located between the washer and an underside of the head of the mounting bolt that is configured to impart an outward biasing force to the underside of the head of the mounting bolt in order to bias the fixing component towards the washer. Alternatively, or in addition, the biasing system may comprise at least one tension spring, for example a rubber cord or band, that extends between the fixing component and the washer and is configured to bias the fixing component towards the washer directly. The biasing system may optionally comprise a first tension spring that extends between the fixing component and the washer on a first side of the mounting bolt and a second tension spring that extends between the fixing component and the washer on an opposed second side of the mounting bolt. The biasing system may help to bias the fixing component into contact with an inside of a panel during installation of the mounting device, thereby facilitating tightening of the mounting device.

In some embodiments the fixing component anti-rotation means is arranged to permit axial movement of the fixing component with respect to the washer so that when the mounting bolt is screwed into the fixing component said fixing component is able to travel axially towards the head of the mounting bolt.

The fixing component may be connected to the washer by at least one tether. The tether may comprise a flexible but substantially non-extendable wire or cord. The tether may aid retrieval of the fixing component when the mounting device is disassembled for removal from a panel.

The mounting bolt and/or the washer may be formed of a metal (for example steel, stainless steel or brass) or a plastics material (for example nylon, polylactic acid, polyethylene terephthalate or acrylonitrile butadiene styrene), and may optionally be formed by 3D printing.

According to a further aspect of this invention there is provided a mounting assembly comprising a mounting device as described above coupled to a panel, the mounting bolt extending through an aperture in the panel, the washer engages with the panel to resist movement of the mounting bolt in a first direction from a first side of the panel towards a second side of the panel, and the at least one arm of the fixing component engaging the second side of the panel to resist movement of the mounting bolt in a second direction opposed to the first direction.

The panel may be an outer panel of a hollow wall. The panel may, for example, be a plasterboard panel. However, the mounting device of the present invention may also be used to mount items to other types of walls and panels, especially panels having a comparatively low thickness, including, for example, wooden panels.

The end face of the head of the mounting bolt may be at least substantially level with or inwardly recessed with respect to the first side of the panel.

The mounting assembly may further comprise a fastener in the form of a further mounting bolt, a screw or a nail that is coupled to the mounting point of the mounting bolt and extends outwardly from the end face of the head of the mounting bolt. The fastener may be used to mount an item such as a picture, clock or mounting bracket to the panel.

According to yet another aspect of the present invention there is provided a kit of parts for forming a mounting device that is configured to be coupled to a panel, the kit comprising a mounting bolt, a fixing component, and a washer as described above.

The washer may comprise a hollow body that is configured to receive at least a portion of the head of the mounting bolt therein, and a base that comprises a central aperture and an engagement surface around the central aperture, the central aperture being configured to allow the shank of the mounting bolt to pass therethrough and the engagement surface being configured to be engaged by an underside of the head of the mounting bolt in order to prevent the head of the mounting bolt from passing through the central aperture, and at least one engagement formation that is configured to resist movement of the washer through an aperture in which the washer may be placed in use.

The base of the washer may comprise a single wall that extends continuously around the central aperture, in which case the engagement surface may also extend continuously around the central aperture. Alternatively, the base may be formed by a plurality of discrete sections, in which case the engagement surface may be discontinuous.

The head of the mounting bolt may have a thickness from the end face to the underside thereof that is at least substantially equal to or less than a length of the washer from the engagement surface of the base of the washer to a proximal end of the hollow body. This advantageously allows the entire head of the mounting bolt from the underside to the end face thereof to be received within the hollow body of the washer, with the end face of the head of the mounting bolt being at least substantially level with or recessed with respect to the proximal end of the washer when the head of the mounting bolt is seated against the engagement surface of the base of the washer.

The washer may further comprise at least one engagement formation that is configured to resist movement of the washer through an aperture in which the washer may be placed in use. The at least one engagement formation may comprise a flange that extends radially outwardly from the hollow body of the washer and/or a plurality of longitudinally extending fins that extend radially outwardly from the hollow body of the washer.

The kit of parts may further comprise a coil spring that is configured to be located between the head of the mounting bolt and the base of the washer with the shank of the mounting bolt extending therethrough.

The kit of parts may further comprise a fixing component comprising a threaded bore that is configured to be engaged by the external threading on the shank of the mounting bolt and at least one arm that extends outwardly from the portion of the fixing component in which the threaded bore is provided. The fixing component may, for example, comprise a spring toggle or a pivoting toggle bar.

However, it will be appreciated that the mounting bolt and washer may be supplied separately to and used in combination with an existing fixing component.

The fixing component may be connected to the washer by at least one tether, which may comprise a wire or cord, or may be elastically extendable.

It will be appreciated that features of the various different aspects of the present invention described above may be combined with each other in any suitable manner.

### BRIEF DESCRIPTION OF DRAWINGS

Embodiments of the invention will now be described by way of non-limiting example only and with reference to the accompanying drawings, in which:

FIGS. 1 to 4 schematically illustrate a mounting device in accordance with one possible embodiment of the present invention for mounting an item to a plasterboard panel;

FIGS. 5a, 5b, 6a, 6b, 7a and 7b schematically illustrate the mounting device of FIGS. 1 to 4 being mounted to a plasterboard panel and an item in the form of a mounting bracket being coupled thereto;

FIGS. 8 to 13 schematically illustrate further mounting devices in accordance with other possible embodiments of the present invention;

FIGS. 14a and 14b show perspective views of another mounting device in accordance with this invention in different operative positions.

FIG. 15 shows a perspective view of yet another embodiment of the invention.

FIGS. 16a-16g show yet a further embodiment of the invention in exploded, axial cross-section and perspective views.

FIG. 17 shows a particular fastener secured to the mounting device for holding an item to the panel.

FIGS. 18a-18c show an embodiment having a unitarily formed washer and fixing component.

In the Figures like references denote like parts.

### DETAILED DESCRIPTION OF EMBODIMENTS

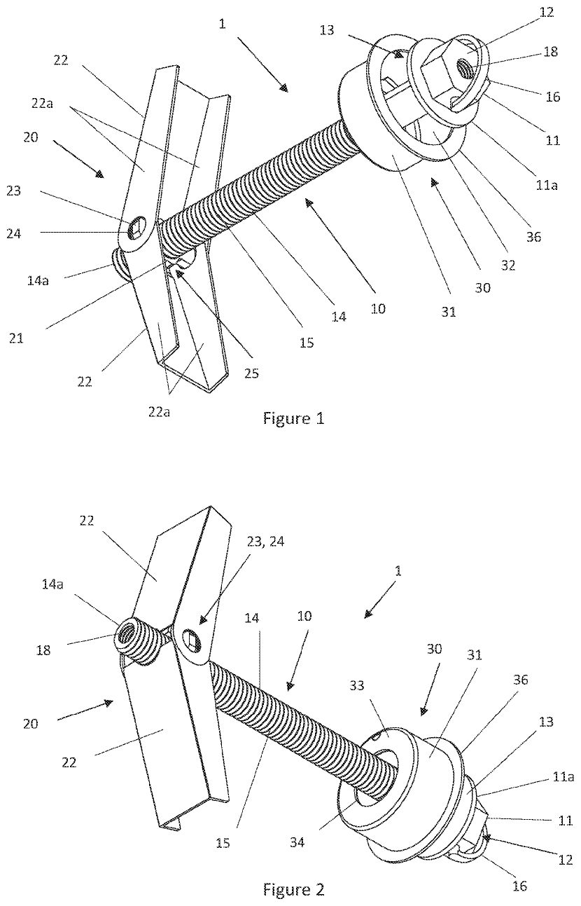

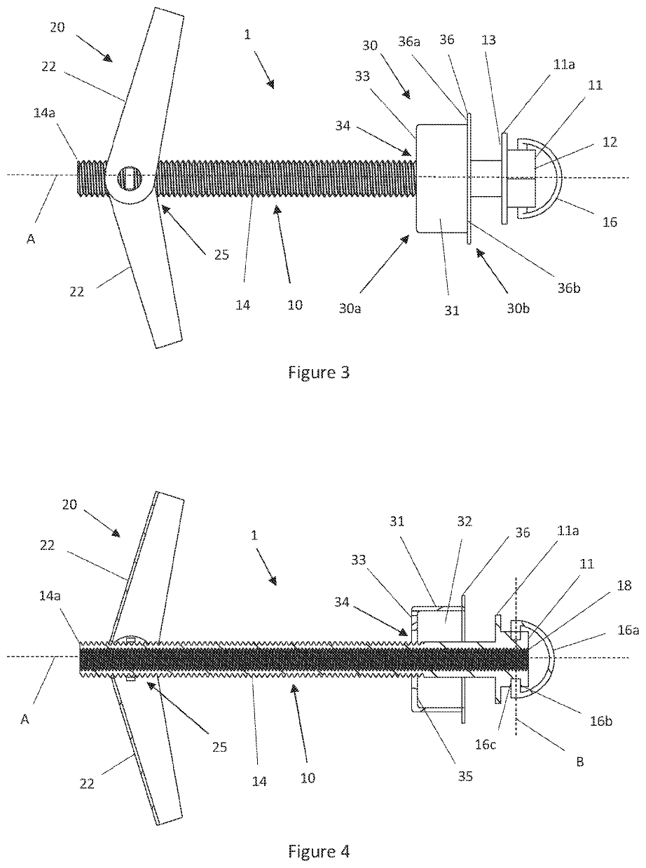

FIGS. 1 to 4 schematically illustrate a device 1 for mounting an item such as a mounting bracket to a plasterboard panel. The mounting device 1 is shown in perspective views in FIGS. 1 and 2, from the side in FIG. 3, and in cross-section in FIG. 4.

As shown in FIGS. 1 to 4, the mounting device 1 comprises a mounting bolt 10, a fixing component or anchor 20 and a locating element, herein referred to as a washer 30 that are coupled together to form the mounting device 1.

The mounting bolt 10 comprises a head 11 having an outer end face 12 and an underside 13 opposed to the end face 12. An elongate shank 14 extends outwardly from the underside 13 of the head 11 of the mounting bolt 10. The shank 14 of the mounting bolt 10 comprises a straight, cylindrical bar with a round cross-section, and extends along a longitudinal axis A of the mounting bolt 10. A proximal portion of the shank 14 of the mounting bolt 10 adjacent to the head 11 is unthreaded. However, the shank 14 of the mounting bolt 10 is provided with external threading 15 along a majority of its length up to a distal tip 14a furthest from the head 11.

The shank 14 of the mounting bolt 10 has a diameter of 8 mm or 5/16 inches and the external threading 15 is standard M8 or 5/16 threading of the type used to engage standard nuts and threaded recesses, although other diameters and types of threading may be used in other embodiments.

The head 11 of the mounting bolt 10 has a hexagonal shape when viewed in a direction aligned with the longitudinal axis A of the mounting bolt 10. However, the head 11 of the mounting bolt 10 also includes an annular flange 11a that extends radially outwardly therefrom at the underside 13 of the head 11 of the mounting bolt 10 such that the head of the mounting bolt is wider at its underside 13 than at its outer end face 12.

The head 11 of the mounting bolt 10 is also provided with a handle 16 that is pivotally connected thereto. The handle 16 comprises an elongate curved or arcuate body 16a and an inwardly-extending boss 16b at each end of the handle body 16a, as best shown in the cross-section view of FIG. 4. The bosses 16b of the handle 16 are received within a corresponding pair of recesses 16c provided on opposite sides of the head 11 of the mounting bolt 10.

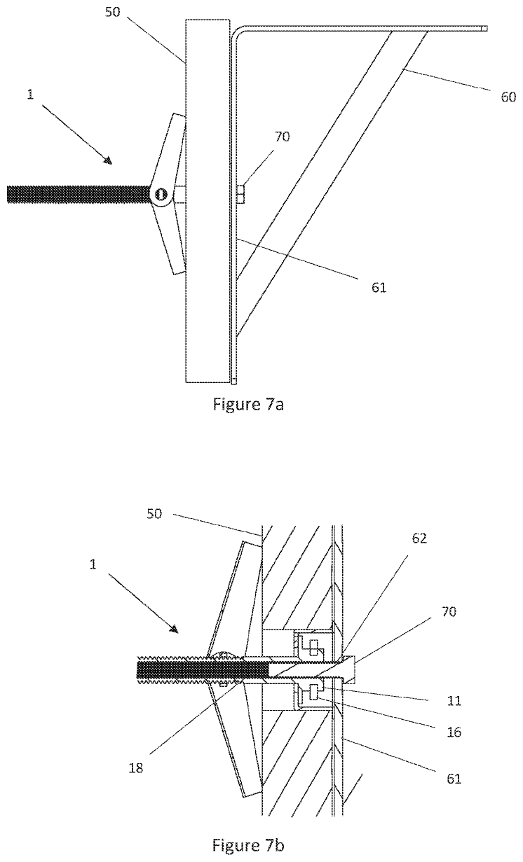

The bosses 16b are pivotable within the recesses 16c such that body 16a of the handle 16 may be pivoted about a transverse axis B that extends through the bosses 16b and the recesses 16c in a direction perpendicular to the longitudinal axis A of the mounting bolt 10. In particular, the arcuate body 16a of the handle 16 is pivotable between a deployed position in which it extends outwardly beyond the end face 12 of the head 11 of the mounting bolt 10 in a plane that is parallel to the longitudinal axis A of the mounting bolt 10 (as shown in FIGS. 1 to 4) and a stowage position in which it extends around one side of the head 11 of the mounting bolt 10 in a plane that is perpendicular to the longitudinal axis A of the mounting bolt 10 without protruding beyond the end face 12 of the head 11 of the mounting bolt 10 (as shown in FIG. 7b).

The mounting bolt 10 further comprises a mounting point in the form of a bore 18 with internal threading that extends through the mounting bolt 10 from the end face 12 of the head 11 of the mounting bolt 10 to the distal tip 14a of the shank 14. The threaded bore 18 is configured to receive and retain a further mounting bolt having a smaller diameter than the mounting bolt 10 that is shown in FIGS. 1 to 4, as described in more detail below.

The fixing component or anchor 20 takes the form of a standard spring toggle comprising a nut 21 having a threaded bore with internal threading that matches the external threading 15 of the shank 14 of the mounting bolt 10. The spring toggle 20 further comprises a pair of arms 22 that are pivotally connected to the nut 21. In particular, the arms 22 of the spring toggle 20 are connected to the nut 21 by a pair of projecting portions 23 that extend radially outwardly from opposite sides of the nut 21 and are received in corresponding apertures 24 provided in sidewalls 22a of each of the arms 22.

The spring toggle 20 further comprises a spring 25 including an inner portion that is wrapped around one of the projecting portions 23 of the nut 21 and a pair of outer portions that project outwardly from the inner portion and engage inner faces of the arms 22 in order to bias the arms 22 outwardly away from each other.

As shown in FIGS. 1 to 4, the nut 21 of the spring toggle 20 is engaged with the threaded shank 14 of the mounting bolt 10, with the arms 22 of the spring toggle 20 facing towards the head 11 of the mounting bolt 10 such that the outer ends of the arms 22 move towards the head 11 of the mounting bolt 10 when the arms 22 are deflected inwardly towards each other against the biasing force of the spring 25.

The washer 30, which is located between the spring toggle 20 and the head 11 of the mounting bolt 10, is a recessed washer comprising a cylindrical outer wall 31 that extends around a central axis between first and second ends 30a, 30b of the washer 30. The first end 30a of the washer 30 is the end that is located towards the distal tip 14a of the shank 14 of the mounting bolt 10 and the spring toggle 20, and the second end 30b of the washer 30 is the end that faces away from the distal tip 14a of the shank 14 of the mounting bolt 10 and the spring toggle 20 when the mounting device 1 is assembled as shown in FIGS. 1 to 4. The outer wall 31 forms a cylindrical hollow body defining an internal area 32 that is configured to receive the head 11 of the mounting bolt 10 therein when the mounting device 1 is tightened around a plasterboard panel, as described in more detail below.

The washer 30 further comprises a base wall 33 that extends radially inwardly from the outer wall 31 at the first end 30a of the washer 30 to form a base of the internal area 32. The base wall 33 comprises a central aperture 34 through which the shank 14 of the mounting bolt 10 extends. The central aperture 34 of the base wall 33 has a diameter that is greater than the diameter of the shank 14 of the mounting bolt 10 such that the shank 14 of the mounting bolt 10 is able to pass therethrough. However, the diameter of the central aperture 34 is narrower than at least the annular flange 11a of the head 11 of the mounting bolt 10. A surface 35 of the base wall 33 that faces towards the internal area 32 of the washer 30 around the central aperture 34 therefore defines an engagement surface that can be engaged by the underside 13 of the head 11 of the mounting bolt 10 in order to prevent the head 11 of the mounting bolt 10 from passing through the central aperture 34.

The washer 30 further comprises an engagement formation in the form of an annular flange 36 that extends radially outwardly from the outer wall 31 at the second end 30b of the washer 30. The flange 36 has an underside 36a that faces towards the first end 30a of the washer 30 and an outer surface 36b that faces away from the first end 30a of the washer 30 and defines a proximal end face of the washer 30.

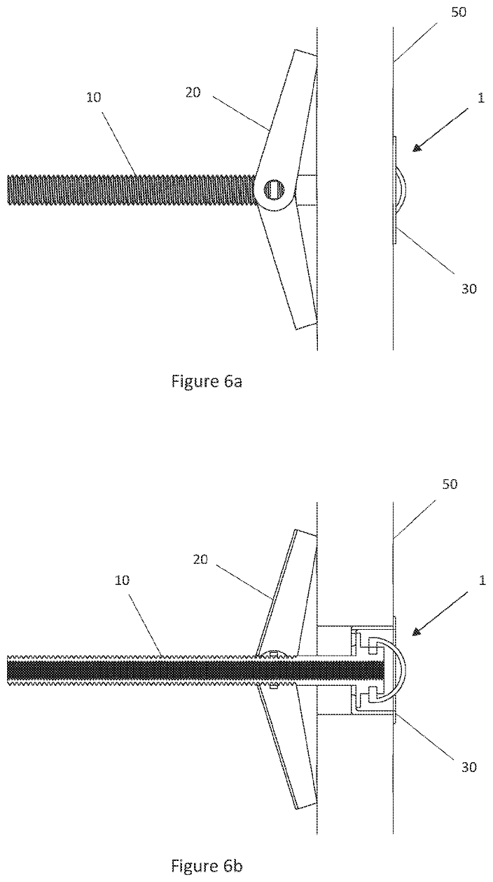

The distance between the engagement surface 35 of the base wall 33 and an outer surface 36b of the annular flange 36 (which defines the proximal end face of the washer 30) is greater than the thickness of the head 11 of the mounting bolt 10 between the end face 12 and the underside 13 thereof such that the entire head 11 of the mounting bolt 10 may be received within the internal area 32 of the washer 30 with the end face 12 of the head 11 of the mounting bolt 10 being inwardly recessed with respect to the proximal outer surface 36b of the washer 30, as shown in FIG. 6b.

The mounting bolt 10, spring toggle 20 and washer 30 may each be formed of a metal such as steel, stainless steel or brass, or of a plastics material such as nylon, polylactic acid, polyethylene terephthalate or acrylonitrile butadiene styrene. The mounting bolt 10, spring toggle 20 and washer 30 may optionally be formed by 3D printing.

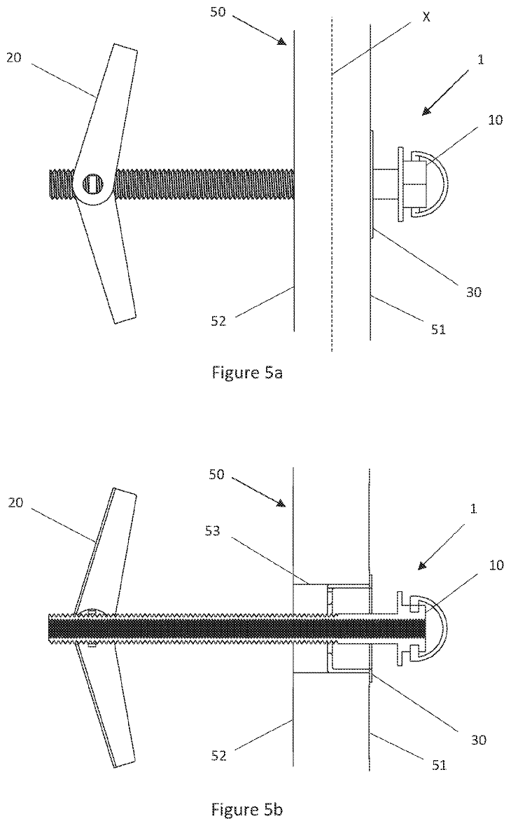

Use of the mounting device 1 shown in FIGS. 1 to 4 to secure an item in the form of a mounting bracket to a plasterboard panel will now be described with reference to FIGS. 5a to 7b.

The plasterboard panel 50, hereafter referred to as ‘the panel’, extends in a vertical plane X and comprises a first surface 51 and a second surface 52 opposed to the first surface 51, as shown in FIGS. 5a and 5b. The first surface 51 of the panel 50 is an exposed front surface that faces towards the interior of a room, while the second surface 52 of the panel 50 is a hidden rear surface.

First, a user of the device 1 marks the position on the front surface 51 of the panel 50 at which it is desired to provide a mounting point for securing the bracket to the panel 50, for example by holding the bracket in the desired position against the front surface 51 of the panel 50 and using a pen or pencil to mark the location of a mounting bolt-receiving aperture provided on a wall-facing portion of the bracket.

Next, an aperture or hole 53 having a diameter that is approximately equal to the outer diameter of the cylindrical wall 31 of the washer 30 is drilled through the thickness of the panel 50 at the location of the mark.

Next, the arms 22 of the spring toggle 20 are pivoted inwardly towards each other to reduce the effective width of the spring toggle 20 and the device 1 is pushed through the hole 53 in the panel 50 until the spring toggle 20 is located on the rear surface of the panel 50 and the cylindrical body 31 of the washer 30 is located inside the hole 53 with the underside 36a of the flange 36 of the washer 30 abutting the front surface 51 of the panel 50, as shown in FIGS. 5a and 5b. Once the spring toggle 20 has passed through the hole 53 in the panel 50 the biasing force imparted to the arms 22 by the spring 25 causes the arms 22 to move back apart from each other, thereby returning the spring toggle 20 to its original expanded configuration, as also shown in FIGS. 5a and 5b. In this configuration the effective width of the arms 22 of the spring toggle 20 is greater than the diameter of the hole 53 in the panel 50 and so the arms 22 prevent the spring toggle 20 (and therefore the device 1 as a whole) from falling back out of the hole 53 in the panel 50.

Next, the handle 16 on the head 11 of the mounting bolt 10 is pivoted into its deployed position in which it extends outwardly beyond the end face 12 of the head 11 of the mounting bolt 10 (if it is not already in this position) and pulled in an outward direction away from the front surface 51 of the panel 50 in order to bring the arms 22 of the spring toggle 20 into contact with the rear surface 52 of the panel 50. Once the arms 22 of the spring toggle 20 are in contact with the rear surface 52 of the panel 50, the handle 16 is used to rotate the mounting bolt 10 in a clockwise direction in order to secure the device 1 with respect to the panel 50. As the mounting bolt 10 is rotated, the shank 14 of the mounting bolt 10 advances through the washer 30 and through the nut 21 of the spring toggle 20 until the underside 13 of the head 11 of the mounting bolt 10 engages the engagement surface 35 of the base wall 33 of the washer 30. The handle 16 may be pulled in the outward direction continuously while the mounting bolt 10 is being rotated in order to keep the arms 22 of the spring toggle 20 are in contact with the rear surface 52 of the panel 50, thereby preventing the spring toggle 20 from rotating together with the mounting bolt 10.

As shown in FIG. 6b, once the underside 13 of the head 11 of the mounting bolt 10 engages the engagement surface 35 of the base wall 33 of the washer 30, the entire head 11 of the mounting bolt 10 from the underside 13 to the end face 12 thereof is located inside the internal area 32 of the washer 30 and the end face 12 of the head 11 of the mounting bolt 10 is inwardly recessed with respect to the outer surface 36b of the washer 30 and the front surface 51 of the panel 50.

Once the mounting bolt 10 and spring toggle 20 have been tightened around the panel 50, as shown in FIGS. 6a and 6b, engagement between the underside 36a of the flange 36 of the washer 30 and the front surface 51 of the panel 50 prevents that device 1 from moving through the hole 53 in a direction towards the rear of the panel 50 and engagement between the arms 22 of the spring toggle 20 and the rear surface 52 of the panel 50 prevents the device 1 from moving through the hole 53 in a direction towards the front of the panel 50, such that the device 1 is securely retained with respect to the panel 50.

When the device 1 has been secured with respect to the panel 50, the handle 16 on the head 11 of the mounting bolt 10 may be pivoted into its stowage position as shown in FIG. 7b so that it does extend over the outer end face 12 of the head 11 of the mounting bolt 10 or obstruct access to the threaded bore 18 provided in the end face 12 of the head 11 of the mounting bolt 10. A bracket 60 may then be moved into the desired position with respect to the panel 50, with a mounting bolt-receiving aperture 62 in the wall-facing portion 61 of the bracket 60 aligned with the mounting bolt 10 of the installed mounting device 1. A further mounting bolt 70 having a shank with external threading that matches the internal threading of the threaded bore 18 of the mounting bolt 10 may then be fed through the mounting bolt receiving aperture 62 and screwed into the threaded bore 18 of the mounting bolt 10 for example using a screwdriver or hex key until the wall-facing portion 61 of the bracket 60 is clamped between the head of the further mounting bolt 70 on one side and the outer surface 36b of the washer 30 and the front surface 51 of the panel 50 on the other side in order to mount the bracket 60 to the panel 50. The mounting bolt 10 and spring toggle 20 will also be naturally tightened around the panel 50 as the further mounting bolt 70 is screwed into the threaded bore 18 of the mounting bolt 10 as the further mounting bolt 70 will impart a clockwise torque to the mounting bolt 10 as it is screwed into the threaded bore 18.

If the bracket 60 includes multiple mounting bolt-receiving apertures 62 then the above-described steps may be performed for a corresponding plurality of the mounting devices 1 in order to secure the bracket 60 to the panel 50 at multiple attachment points.

The mounting device 1 illustrated in FIGS. 1 to 4 could also be used to mount another type of item to the plasterboard panel 50 besides a mounting bracket. For example, if a further mounting bolt was screwed into the threaded bore 18 of the mounting bolt 10 without any mounting bracket being located between the further mounting bolt and the plasterboard panel 50 then the further mounting bolt could be left protruding from the plasterboard panel 50 and an item such as a picture or clock could be hung from the shank of the further mounting bolt 70.

It will be appreciated that the above-described embodiment is included as an example only and that many modifications may be made without departing from the scope of the invention as defined in the accompanying claims.

For example, in other embodiments the spring toggle 20 may be replaced by another type of fixing component or anchor, for example a pivoting toggle bar including a single, rigid arm that is pivotally connected to a threaded nut.

In another embodiment the end face 12 of the head 11 of the mounting bolt 10 may be flush or level with the proximal end face 36b of the washer 30 and the front surface 51 of the panel 50 when the mounting device 1 has been installed on a panel 50 instead of being inwardly recessed as in the above-described embodiment.

In another embodiment the handle 16 on the head 11 of the mounting bolt 10 may be omitted. In this case the mounting bolt 10 may be rotated using a wrench, spanner or socket in order to tighten the mounting bolt 10 and fixing component 20 around the panel 50.

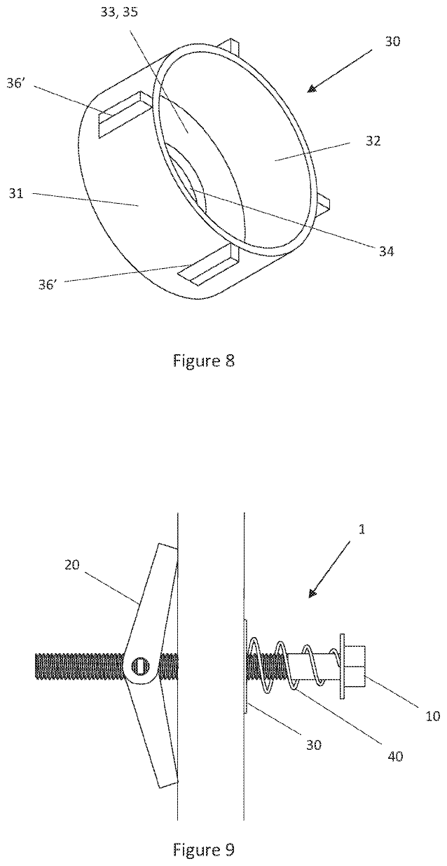

In another embodiment the washer 30 may include a plurality of longitudinally extending fins 36′ that extend radially outwardly from the cylindrical body 31 of the washer 30 instead of or in addition to the annular flange 36, as shown in FIG. 8. It will be appreciated that the longitudinally extending fins 36′ of the washer illustrated in FIG. 8 are capable of performing the same function of resisting movement of the washer 30 through a hole in a panel as the annular flange 36 of the washer 30 illustrated in FIGS. 1 to 7.

In another embodiment a coil spring 40 may be provided around the shank 14 of the mounting bolt 10 between the washer 30 and the head 11 of the mounting bolt 10, as shown in FIG. 9.

The spring 40 is configured to impart a biasing force to the underside 13 of the head 11 of the mounting bolt 10 to bias the mounting bolt 10 in an outward direction away from the washer 30. The inclusion of such a spring facilitates tightening of the mounting device 1 onto a panel by biasing the fixing component 20 of the device 1 into contact with the rear surface of the panel during installation of the device 1.

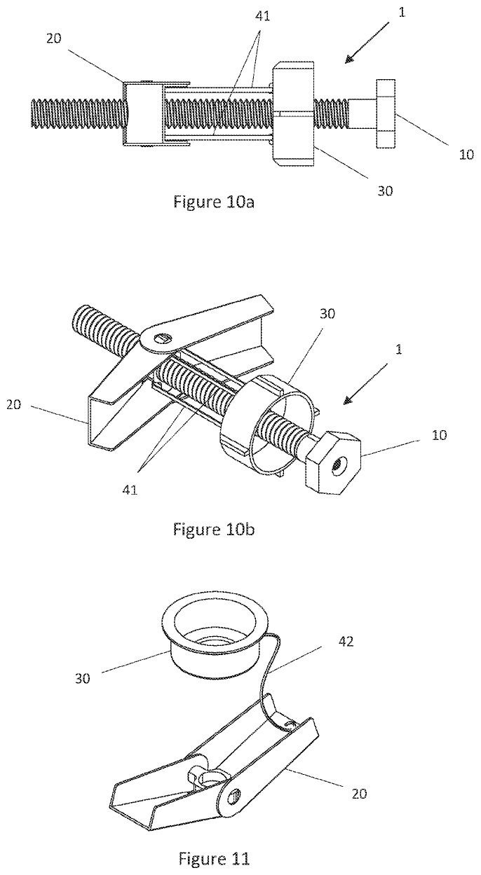

In another embodiment the mounting device 1 may include a pair of rubber bands 41 that extend between the fixing component 20 and the washer 30 on opposing sides of the mounting bolt 10, as shown in FIGS. 10a and 10b. Each of the rubber bands 41 extends around one of the projecting portions 23 of the nut 21 of the fixing component 20 and is connected to the washer 30 by an attachment hook or loop provided on an underside of the base wall 33 of the washer 30. Similarly, to the coil spring 40 of the embodiment illustrated in FIG. 9, the rubber bands 41 facilitate tightening of the mounting device 1 onto a panel by biasing the fixing component 20 of the device 1 into contact with the rear surface of the panel during installation of the device 1.

In another embodiment the fixing component 20 may be connected to the washer 30 by a flexible tether in the form of a wire or cord 42, as shown in FIG. 11. The tether 42 aids retrieval of the fixing component 20 if/when the mounting device 1 is disassembled for removal from a panel on which it has been installed.

In other embodiments the mounting point that is provided in the end face 12 of the head 11 of the mounting bolt 10 may comprise a deformable core 18′ that is configured to receive and retain a screw with a self-tapping thread or a nail instead of a threaded bore that is configured to receive and retain a further mounting bolt.

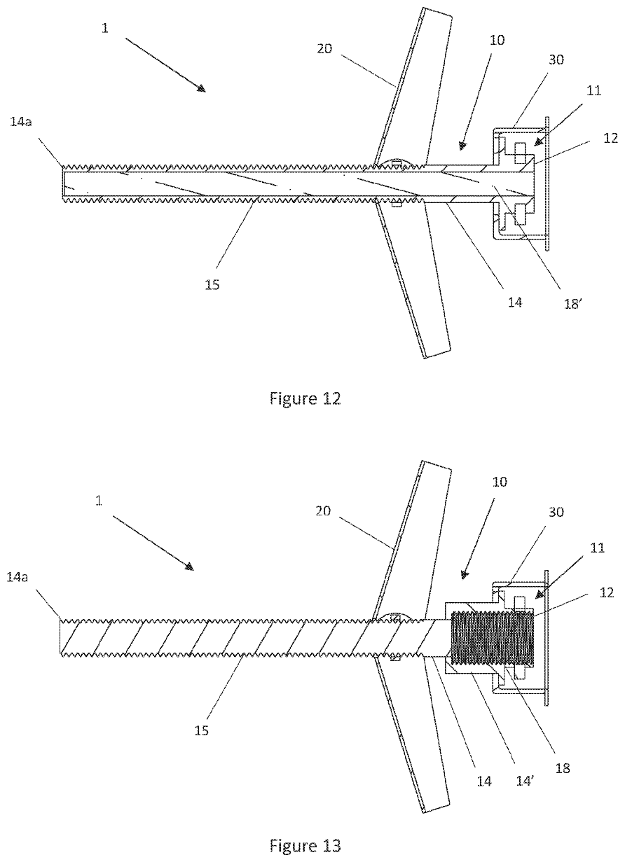

For example, FIG. 12 illustrates an alternative embodiment of the present invention in which the mounting bolt 10 of the mounting device 1 comprises a deformable core 18′ formed of a wood or plastics material that extends along the length of the mounting bolt 10 from the end face 12 of the head 11 of the mounting bolt 10 to the distal tip 14a of the shank 14.

This deformable core 18′ is able to receive and retain a screw or nail, which may be used to mount an item to a plasterboard panel on which the mounting device 1 has been installed. As shown in FIG. 12, the deformable core 18′ is formed as a solid block and does not include any central guide aperture, which allows a screw or nail to be introduced into the deformable core 18′ at any desired location or angle without being automatically aligned with the central axis of the mounting bolt 10.

In the above-described embodiments the threaded bore 18 or deformable core 18′ which provides the mounting point for a further fastener in the end face 12 of the mounting bolt 10 of the mounting device 1 extends along the entire length of the mounting bolt 10 (through the head 11 and the entire shank 14 of the mounting bolt 10). However, in other embodiments the mounting point may extend only a portion of the way along the length of the mounting bolt 10.

For example, FIG. 13 illustrates an alternative embodiment of the present invention in which the threaded bore 18 of the mounting bolt 10 only extends through the head 11 of the mounting bolt 10 and through an enlarged section 14′ of the shank 14 of the mounting bolt 10 located adjacent to the head 11 of the mounting bolt 10. This mounting bolt design allows the threaded bore 18 of the mounting bolt 10 to be formed with a greater diameter compared to the threaded portion 15 of the shank 14 of the mounting bolt 10 than in the embodiment illustrated in FIGS. 1 to 4, optionally a diameter that is greater than that of the threaded portion 15 of the shank 14 of the mounting bolt 10. This enables the mounting device 1 to receive and retain a further mounting bolt having a larger diameter and/or to have a smaller diameter shank and to use a smaller fixing component. It will be appreciated that the embodiment illustrated in FIG. 13 could also be modified to include a deformable core of similar dimensions in place of the widened threaded bore.

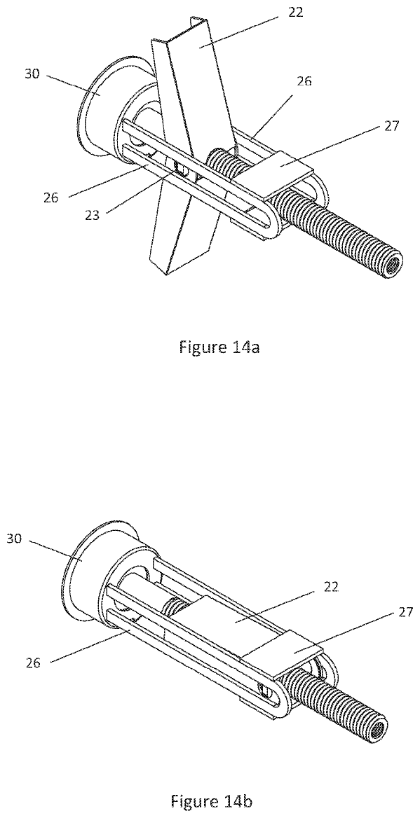

Referring to FIGS. 14a and 14b, in this embodiment, which is similar to that shown in FIGS. 1-13 , the arms 22 are reciprocal and prevented from rotating by the projecting portions 23 being axially movable within U-shaped guide members 26 secured to the washer and spaced apart at a distal end from the washer 30 by opposed spacers 27. The arms 22 are shown in an open position in FIG. 14a and in a closed position nested between the guide members 26 in FIG. 14b. The spacers also serve to close the arms 22 from a panel engaging, open, position to a closed position where the fixing component is insertable through an aperture in the panel by the arms contacting the spacers when moved along the mounting bolt screw thread away from the washer 30.

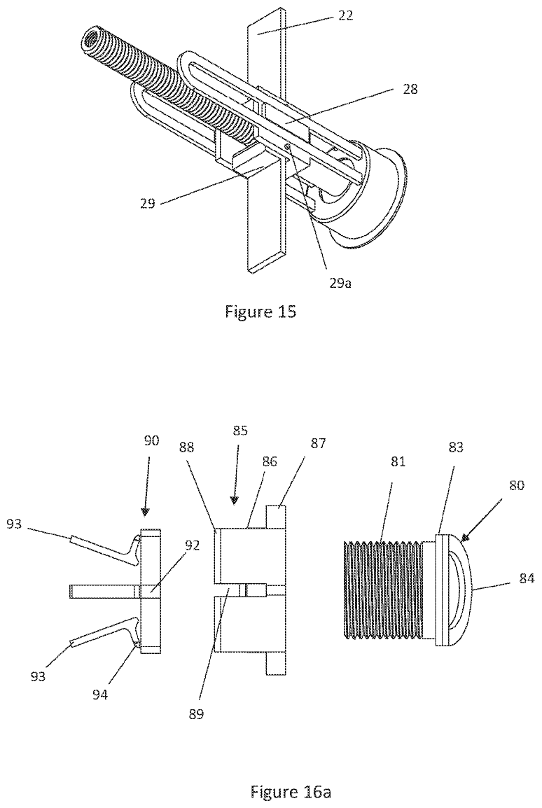

FIG. 15 shows another version of the mounting device which is similar to that shown in FIGS. 14a, 14b except that the nut 21 includes a rectangularly-shaped member 28 for locating between each of the U-shaped guide members. Each of the arms 22 has, at a radially inner end thereof, a depending member 29 which is arranged to be contacted by the mounting bolt as it is screwed through the nut to move the arms radially outwardly about a respective pivot 29a.

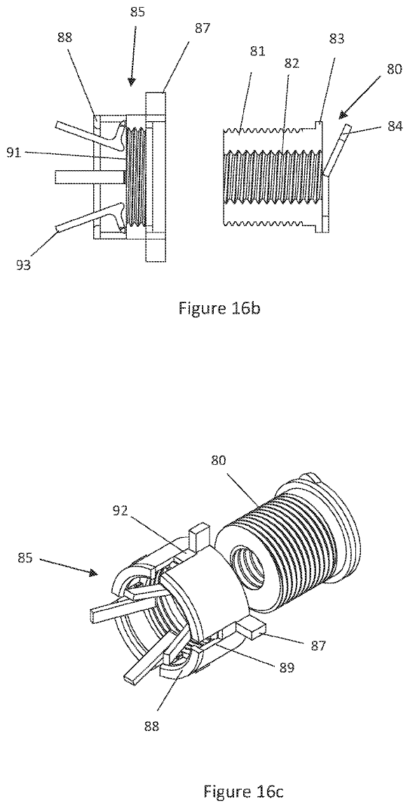

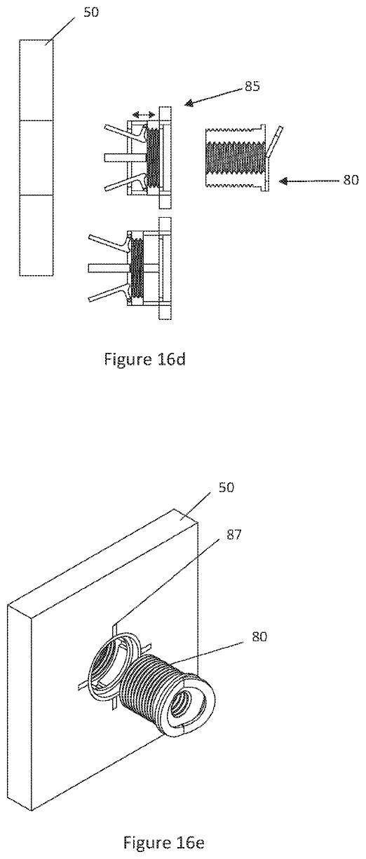

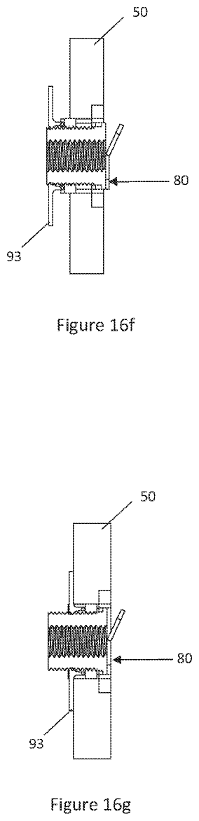

Referring now to FIGS. 16a-16c, the mounting bolt 80 has an external screw thread 81 and an internal screw thread 82, an annular flange 83 and a flexible handle 84.

The washer 85 has a cylindrical outer wall 86, four equi-circumferentially spaced fins 87 and an end wall 88 axially spaced from the fins 87. The fixing component 90 is analogous to the fixing component 20 and has an internal screw thread 91 for cooperating with the external screw thread 81 of the mounting bolt 80. Mounted on the external side wall of the fixing component are opposed flanges 92 which are arranged to slide within diametrically opposed slots 89 in the washer to thereby prevent the fixing component from rotating with respect to the washer. The fixing component 90 includes L-shaped arms 93 having a proximal end 94 flexibly attached to the fixing component in a hinge-like manner.

The components are shown in a disassembled form in FIG. 16a and the end wall 88 is made of flexible material such that the fixing component 90 may be axially pushed therethrough into the washer 85, the end wall 88 thereafter preventing axial movement of the fixing component so that it does not fall out of the washer when the mounting bolt is introduced into the fixing component.

Axial movement of the mounting bolt, by being threadably inserted into the fixing component, causes the arms to flex and be moved radially outwardly as shown in FIG. 16f and continued insertion of the mounting bolt into the fixing component draws the fixing component, in operation, toward the rear (inner) first surface of the panel (as shown in FIG. 16g) to thereby secure the mounting device in position in the panel. Like the previous embodiments, the mounting bolt has an inner core, which may be threaded as shown in FIGS. 16a-16c, or be solid to receive a screw or a nail.

The mounting device of this embodiment is shown in FIGS. 16d-16g with respect to a panel. In FIG. 16d the mounting device is shown in longitudinal cross-section and the double arrow-headed line indicates axial movement of the fixing component relative to the washer 85. In FIG. 16e, the fixing component is located into an aperture in the panel ready for insertion of the mounting bolt, FIG. 16f shows the arms rotated toward a fixing position and FIG. 16g shows the mounting device secured to the panel.

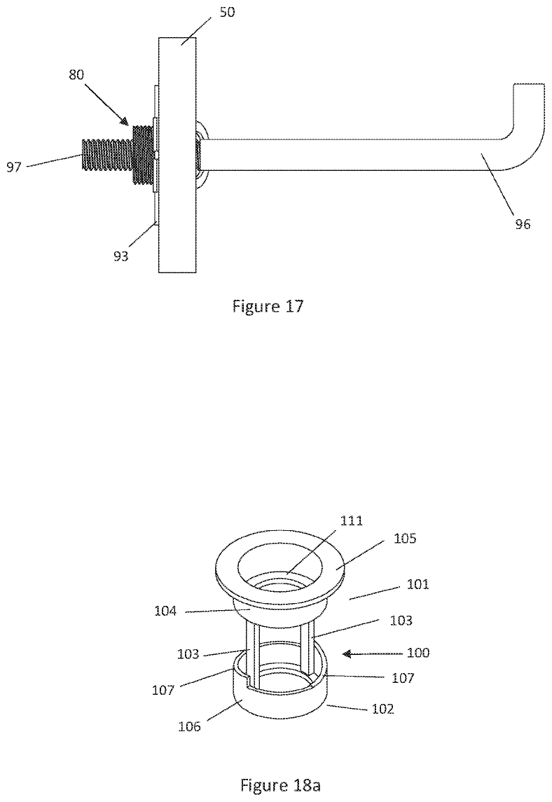

In FIG. 17, a fastener 96 is shown in the form of an L-shaped hook having an external threaded portion 97 for cooperating with the internal thread of the mounting bolts 10, 80.

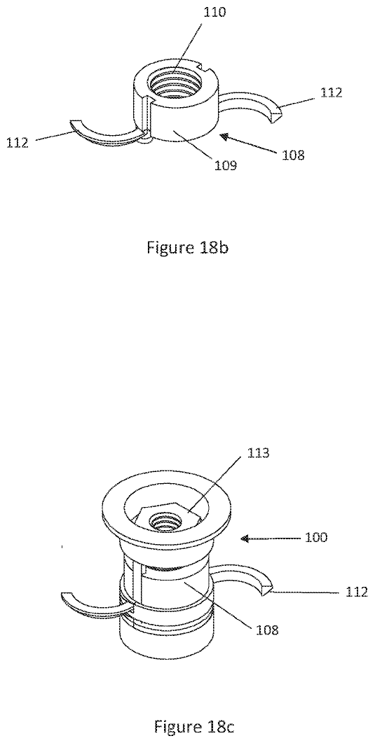

Another embodiment of the invention has a unitarily formed washer and fixing component shown in FIGS. 18a-18c.

Referring particularly to FIG. 18a, a washer 100 has, on its longitudinal axis, an upper part 101 and a lower part 102 which are joined by diametrically opposed posts 103. The upper part is similar to the washer 30, shown in FIGS. 1-13, and has an outer cylindrical wall 104 with an uppermost (as shown in the Figures) annular flange 105.

The lower part 102 has a cylindrical wall 106, a lower end wall extending radially inwardly to capture the fixing component 108 and with an upper (as shown in FIG. 18a) end wall arcuately formed to provide a pair of opposed cam surfaces 107.

The fixing component 108, shown in FIG. 18b, has a hollow cylindrical body 109 formed with an internal screw thread 110 for cooperating with the mounting bolt having an external screw thread and an annular flange to abut against an internal flange 111 in the upper part 101 of the washer 100. The body 109 has diametrically opposed slots in the outer side wall for slidable location on the posts 103 so that the fixing component 108 is mounted between the upper part 101 and lower part 102. It is envisaged that the washer 100 and fixing component 108 will be assembled to the posts 103 before the posts are secured to either the upper part 101 or the lower part 102.

The fixing component has a pair of pivotally mounted arcuate arms 112 that are sprung-loaded to open, as shown in FIG. 18b, or which may be nested underneath the body 109, the arms being movable along the cam surfaces 107. The assembly, includes a hexagonal headed mounting bolt 113 (shown in FIG. 18c) having an external thread for cooperating with the internal thread 110 and the mounting bolt also has an internal thread for receiving a fastener such as that shown in FIG. 17.

In assembling this embodiment to a panel, the arms 112 are closed for insertion through an aperture in the panel and the arms are able to be closed by the mounting bolt withdrawing the upper and lower parts together so that the arms move along the cam surfaces to close the arms so that the assembly may be withdrawn from a panel if required.

In the above-described embodiments, the mounting device 1 is provided as a pre-assembled unit comprising a mounting bolt 10, a spring toggle 20 and a washer 30. However, in other embodiments the mounting bolt 10, spring toggle 20 and washer 30 may be provided as a kit of parts or as individual items and assembled together by a user before being installed on a panel.

Other modifications and variations falling within the scope of the appended claims will also be apparent to the skilled person.

1. A mounting device that is configured to be coupled to a panel, the mounting device comprising:
a mounting bolt comprising a head and a shank that is provided with external threading, and an end face of the head of the mounting bolt is provided with a mounting point that is configured to receive and retain a fastener for mounting an item to the panel;
a fixing component comprising a nut having a threaded bore that is engageable with the external threading of the shank of the mounting bolt and at least one arm pivotably mounted to the fixing component and alterable between an insertable condition and an engageable condition, wherein in the insertable condition the fixing component is insertable through an aperture in said panel from a first side of said panel, and in the engageable condition at least one arm is engageable with a second side of the panel; and
a washer having:
a hollow body that is configured to be received within the aperture in the panel;
at least one engagement formation that is configured to resist movement of the washer through the aperture in the panel;
at least one engagement surface configured to be engaged by an underside of the head of the mounting bolt in order to prevent the head of the mounting bolt from passing through the hollow body;
wherein:
the head of the mounting bolt is configured to be at least partially received within the hollow body of the washer when the underside of the head of the mounting bolt engages the engagement surface.

2. A mounting device according to claim 1 wherein the at least one arm is arranged to articulate around an axis that is tangential to a longitudinal axis of the washer, fixing component and mounting bolt.

3. A mounting device as claimed in claim 1 wherein the at least one arm has an articulation axis which is coaxial with a longitudinal axis of the washer, fixing component and mounting bolt.

4. A mounting device according to claim 1, wherein each at least one arm is secured by a pin received into a mounting block formed on the fixing component.

5. A mounting device according to claim 1, wherein the at least one arm is an integral part of the fixing component secured thereto by a resiliently deformable hinge region.

6. A mounting device according to claim 1, further comprising a biasing system that is configured to urge the at least one arm to the engageable condition.

7. A mounting device according to claim 1, wherein the at least one arm of the fixing component includes hinged arm means arranged to be contacted and rotated by the mounting bolt when the mounting bolt is inserted into the fixing component to cause the arms to articulate from the insertable condition to the engageable condition.

8. A mounting device according to claim 1, wherein the fixing component comprises a spring toggle or a pivoting toggle bar.

9. A mounting device according to claim 1, wherein the mounting point comprises a threaded bore that is configured to receive a threaded shank of a fixing bolt or machined screw.

10. A mounting device according to claim 1, wherein the mounting point comprises a deformable core that is configured to receive a screw with a self-tapping thread or a nail.

11. A mounting device according to claim 10, wherein the deformable core comprises a solid block of wood or plastics material.

12. A mounting device according to claim 1, wherein the head of the mounting bolt is configured to be engaged by a tool in order to facilitate rotation of the mounting bolt during installation of the mounting device.

13. A mounting device according to claim 1, wherein the head of the mounting bolt is provided with a handle that is pivotable with respect to the head of the mounting bolt between a stowage position and a deployed position, wherein the handle extends outwardly beyond the end face of the head of the mounting bolt and is configured to be gripped, in order to facilitate rotation of the mounting bolt when in the deployed position.

14. A mounting device according to claim 1 wherein the entire head of the mounting bolt is configured to be received within the hollow body of the washer.

15. A mounting device according to claim 1, wherein the at least one engagement formation comprises a flange that extends radially outwardly from the hollow body of the washer and/or a plurality of longitudinally extending fins that extend radially outwardly from the hollow body of the washer.

16. A mounting device according to claim 1, further comprising at least one retaining element for preventing the fixing component from completely separating at a distal end of the washer.

17. A mounting device according to claim 1, wherein the washer has a cylindrical outer wall in which are disposed slots and the fixing component has flanges which are arranged to slide within said slots in the washer to thereby prevent the fixing component from rotating with respect to the washer and the fixing component is axially slidable within said washer, and said washer has restraining means for retaining the fixing means within the washer.

18. A mounting device according to claim 17, wherein the washer has spaced along its longitudinal axis, an upper part and a lower part which are joined by posts and said fixing component has external slots in an outer side wall of the fixing component for axially slidable location on the posts, whereby the fixing component is mounted between the upper part and the lower part.

19. A mounting device according to claim 18 wherein the lower part at a distal end from the upper part has an end wall extending radially inwardly to capture the fixing component between the upper part and the lower part.

20. A mounting device according to claim 1, wherein the washer further includes arm engagement means that are arranged to contact the at least one arm, whereby when the fixing component travels axially from the engageable position to the insertion position so the arm engagement means urge the at least one arm means to pivot from the engageable condition to the insertable condition.

21. A mounting device according to claim 1, wherein the washer includes fixing component anti-rotation means arranged to cooperate with the fixing component to prevent the fixing component from rotating with respect to said washer.

22. A mounting device according to claim 21, wherein the fixing component anti-rotation means is arranged to permit axial movement of the fixing component with respect to the washer so that when the mounting bolt is screwed into the fixing component said fixing component is able to travel axially towards the head of the mounting bolt.

23. A mounting device according to claim 1, further comprising a biasing system that is configured to bias the fixing component in a direction towards the washer during installation of the mounting device.

24. A mounting device according to claim 23, wherein the biasing system comprises a compression spring located between the washer and an underside of the head of the mounting bolt.

25. A mounting device according to claim 23, wherein the biasing system comprises at least one tension spring that extends between the fixing component and the washer.

26. A mounting device according to claim 1, wherein the fixing component is connected to the washer by at least one tether.

27. A mounting assembly comprising a mounting device according to claim 1 coupled to a panel, wherein the mounting bolt extends through an aperture in the panel, the washer engages with the panel and resists movement of the mounting bolt in a first direction from a first side of the panel towards a second side of the panel, and the at least one arm of the fixing component engages the second side of the panel and resists movement of the mounting bolt in a second direction opposed to the first direction.

28. A kit of parts for forming a mounting device made in accordance with claim 1.
